(19) United States
(12) Patent Application Publication
(10) Pub. No.: US 2014/0185945 A1
(43) Pub. Date: Jul. 3, 2014

(54) MODIFIED DP SEARCH FOR 2D/3D MAP COMPRESSION

(71) Applicant: CATERPILLAR INC., Peoria, IL (US)

(72) Inventors: Wei Li, Peoria, IL (US); Amit Jayachandran, Peoria, IL (US); Steven C. Budde, Dunlap, IL (US)

(73) Assignee: CATERPILLAR INC., Peoria, IL (US)

(21) Appl. No.: 13/731,884

(22) Filed: Dec. 31, 2012

(51) Int. Cl. G06T 9/00

(52) U.S. Cl. CPC G06T 9/00
USPC 382/232

(57) ABSTRACT

This disclosure is generally drawn to methods, systems, devices and/or apparatus related to compressing the size of engineering development maps. Specifically, some of the disclosed example methods, systems, devices and/or apparatus relate to compression of an engineering development map (e.g., kinematic map) based on a given fixed size and/or based on a given target error tolerance value using modified Douglas-Peucker search techniques.

### TECHNICAL FIELD

The present disclosure generally relates to compressing engineering development maps. More specifically, the present disclosure relates to compressing two dimensional and three dimensional engineering development maps (e.g., machine maps, engine maps) using gradient search techniques.

### BACKGROUND

The present disclosure contemplates that certain aspects of machines may be represented by two or three dimensional engineering development maps. Engineering development maps may include machine maps, engine maps, and the like. Example maps may include kinematic maps, power loss maps, and other maps stored in the machine's onboard storage, among others.

The present disclosure contemplates that machines, including construction vehicles, for example, that include moving parts may be represented as kinematic maps based on known kinematic principles and equations. For example, the state and/or motion of a wheel loader vehicle may be expressed on a kinematic map. Such a kinematic map may correspond to the angle of the wheel loader's bucket, the wheel loader's lift cylinder extension, and/or the wheel loader's tilt cylinder extension, for example. Kinematic maps may be generated via actual measurements and/or calculations. Kinematic maps may be expressed in two dimensions or three dimensions depending on operator requirements.

Kinematic maps having relatively large dimensions (or size) may be burdensome to the electronic control module of a machine and the owner/operator of a machine. For example, some large size kinematic maps (e.g., 500×800 units) may require more storage than a machine has available. In some examples, some large size kinematic maps may require too many computing resources to calculate and/or utilize efficiently. Additionally, owners/operators may have certain operating parameters. To assist machine owners/operators, reducing the size of kinematic maps (and other engineering development maps) may be desirable. For example, an owner/operator may desire a reduced size kinematic map based on a fixed size (due to limitations on storage) and/or based on a target error tolerance.

### SUMMARY

In a first aspect, an example method of compressing a kinematic map representative of kinematic information of a machine is provided. The kinematic map may have initial size. The example method may include removing at least a portion of the kinematic map, replacing the removed portion with linear estimated numerical values, receiving a target error tolerance and/or a fixed size, and reducing the kinematic map from the initial size to a reduced size based, at least in part, on the interpolation error the target error tolerance and/or the fixed size. Such example method may generate a reduced size kinematic map.

In a second aspect, an example method of compressing a kinematic map representative of kinematic information of a machine is provided. The kinematic map may have initial size. The example method may include removing a portion of the kinematic map, replacing the removed portion with linear estimated numerical values; receiving a target error tolerance and/or a fixed size, reducing the kinematic map to a reduced size based on the interpolation error and the target error tolerance and/or the fixed size to generate a reduced size kinematic map. The example method may also include generating an interpolation error map based on the reduced size, determining, from the interpolation error map, minimum values for a characteristic of the kinematic information of the machine and maximum values for the characteristic of the kinematic information of the machine, reducing the minimum values for the characteristic and the maximum values for the characteristic to the reduced size, and searching at least one axis of the reduced size kinematic map to identify values in the reduced size kinematic map that are within the target error tolerance.

In a third aspect, an example method of compressing a kinematic map representative of kinematic information of a wheel loader is provided. The kinematic map may have initial size. The example method may include removing a portion of the kinematic map, replacing the removed portion with linear estimated numerical values, receiving a target error tolerance and/or a fixed size, reducing the initial size of the kinematic map to a reduced size based on the interpolation error and the target error tolerance and/or the fixed size to generate a reduced size kinematic map. The example method may also include generating an interpolation error map based on the reduced size, determining, from the interpolation error map, minimum bucket angles of the wheel loader and maximum bucket angles of the wheel loader, reducing minimum bucket angles of the wheel loader and the maximum bucket angles of the wheel loader to the reduced size, and searching at least one axis of the reduced size kinematic map to identify values in the reduced size kinematic map that are within the target error tolerance.

In a fourth aspect, an example non-transitory storage medium including machine-readable instructions stored thereon is provided. The machine-readable instructions, when executed by one or more processing units of a computing device, may operatively enable the computing device to compress a kinematic map representative of kinematic information of a machine, the kinematic map having an initial size. Such compressing may include removing at least a portion of the kinematic map, replacing the removed portion with linear estimated numerical values, receiving a target error tolerance and/or a fixed size, and reducing the kinematic map from an initial size to a reduced size based, at least in part, on the interpolation error and the target error tolerance and/or the fixed size to generate a reduced size kinematic map.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 depicts a graphical view of an example 2D kinematic map;

FIG. 2 depicts a graphical view of an example 3D kinematic map;

FIG. 3 depicts a graphical view of the example 3D kinematic map of FIG. 2 with portions removed;

FIG. 4 depicts a graphical view of the example 3D kinematic map of FIG. 3 with the removed portions replaced with linear estimated numerical values;

FIG. 5 depicts a graphical view of the X-Y axis of the example 3D kinematic map of FIG. 3;

FIG. 6 depicts a graphical view of the X-Y axis of the example 3D kinematic map of FIG. 4;

FIG. 7 depicts a graphical view of an example 3D interpolation error map;

FIG. 8 depicts a graphical view of the X-Z axis of the example 3D interpolation error map of FIG. 7;

FIG. 9 depicts a graphical view of example maximum bucket angles of a bucket;

FIG. 10 depicts a graphical view of example minimum bucket angles of a bucket;

FIG. 11 depicts a graphical view of an example 3D kinematic map depicting example bucket angle lift gain;

FIG. 12 depicts a graphical view of an example reduced size 3D kinematic map depicting example bucket angle lift gain of FIG. 11;

FIG. 13 depicts a graphical view of an example 3D kinematic map depicting example bucket angle tilt gain;

FIG. 14 depicts a graphical view of an example reduced size 3D kinematic map depicting example bucket angle tilt gain of FIG. 13;

FIG. 15 depicts a graphical view of an example reduced size 3D kinematic map of FIG. 2;

FIG. 16 depicts a graphical view of an example 3D interpolation error map of example bucket angle error of FIG. 15; FIG. 17 depicts a graphical view of the X-Z axis of the example 3D interpolation error map of FIG. 16;

FIG. 18 depicts a graphical view of an example reduced size 3D based on an example given fixed size;

FIG. 19 depicts a graphical view of an example 3D interpolation error map of example bucket angle error of FIG. 18;

FIG. 20 depicts a graphical view of the X-Z axis of the example 3D interpolation error map of FIG. 19;

FIG. 21 depicts a graphical view of an example 2D kinematic map of minimum bucket angle based on an example given target error tolerance;

FIG. 22 depicts a graphical view of an example 2D interpolation error map of FIG. 2

FIG. 23 depicts a graphical view of an example 2D kinematic map of minimum bucket angle based on an example given fixed size;

FIG. 24 depicts a graphical view of an example 2D interpolation error map of FIG. 23;

FIG. 25 depicts an example method of pressing an example kinematic map;

FIG. 26 depicts another example method of compressing an example kinematic map; and

FIG. 27 depicts yet another example method of compressing an example kinematic map, all arranged in accordance with at least some embodiments of the present disclosure.

### DETAILED DESCRIPTION

It should be noted that the methods and systems described herein may be adapted to a large variety of engineering development maps, and are not limited to kinematic maps. For example, other types of engineering development maps, such as machine maps, engine maps, power loss maps, and other maps stored in the machine's onboard storage may benefit from the methods and systems described. For brevity, kinematic map examples are described herein.

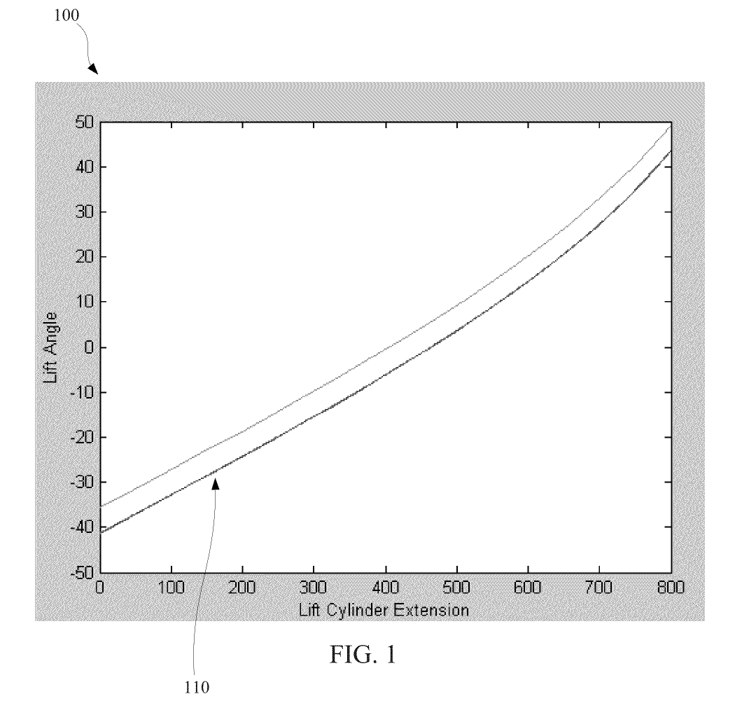

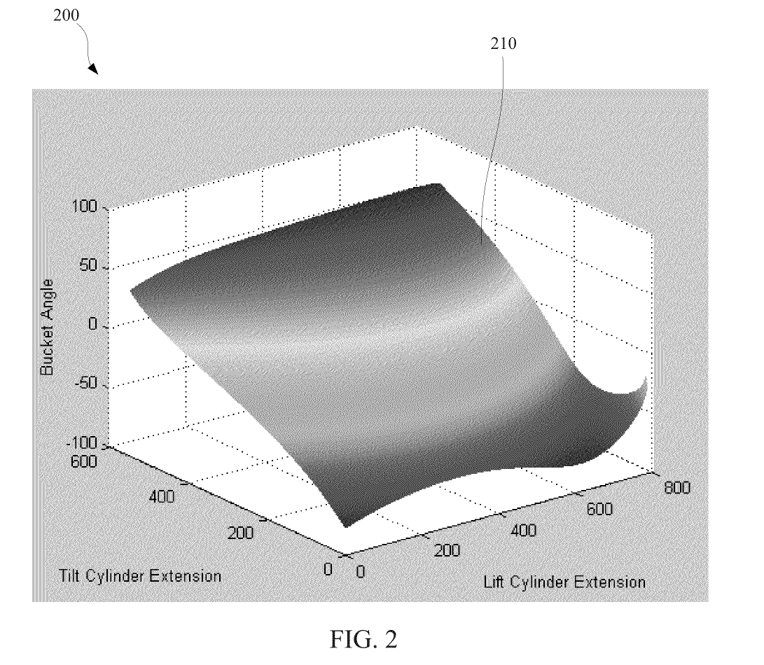

FIGS. 1 and 2 depict graphical views of an example 2D kinematic map 100 and an example 3D kinematic map 200, respectively. Both FIGS. 1 and 2 depict kinematic maps 100, 200 representative of a wheel loader having a bucket. The wheel loader includes several extension mechanisms to move the bucket during operation. Example mechanisms include lift extensions to lift the bucket and tilt extensions to tilt the bucket. These extension mechanisms and other factors affect the angle of the bucket. Understanding the location, angle, tilt, linkage information, and other operational parameters of the bucket may be useful during operation of the wheel loader. It should be noted that the methods and systems described herein may be adapted to a large variety of machines, and are not limited to wheel loaders. For example, other types of industrial machines, such as backhoe loaders, compactors, feller bunchers, forest machines, industrial loaders, skid steer loaders, and many other machines may benefit from the methods and systems described.

FIG. 1 shows a 2D kinematic map 100 representing the lift cylinder extension and the lift angle. Kinematic map 100 may include one or more continuous lines 110 representative of two characteristics of a machine (e.g., lift angle with respect to lift cylinder extension). FIG. 2 shows a 3D kinematic map 200 representing the bucket angle, the lift cylinder extension, and the tilt cylinder extension. Kinematic map 200 may include a 3-dimensional plot 210 (having an initial size of 546×801) representative of three characteristics of a machine (e.g., bucket angle with respect to lift cylinder extension and the tilt cylinder extension). As used herein, the term “kinematic map” may be used interchangeably with the 2-dimensional plot(s) and/or the 3-dimensional plot(s) depicted in the Figures.

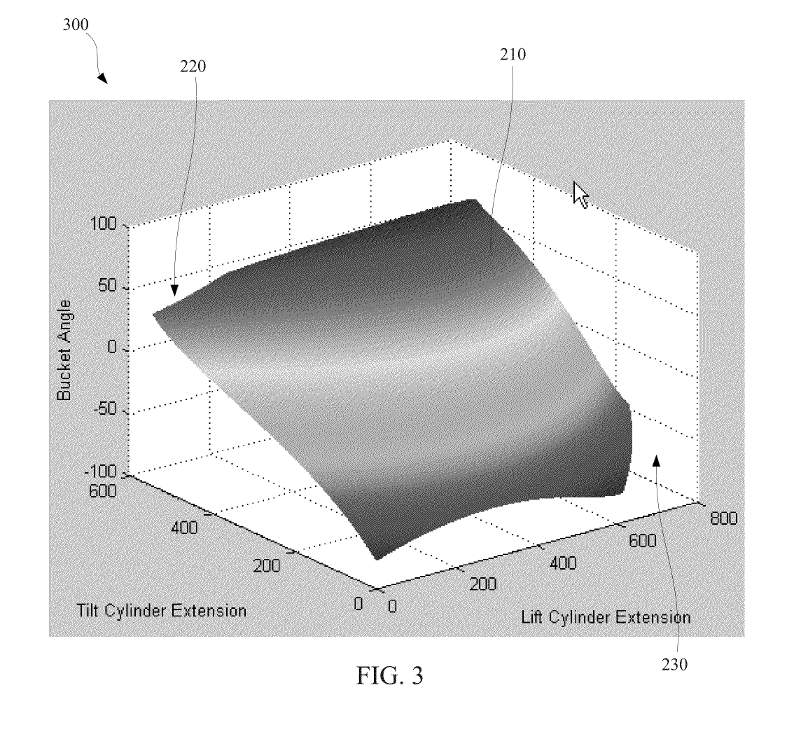

FIG. 3 depicts a graphical view of the example 3D kinematic map 300 of FIG. 2 with two portions removed 220, 230 from the 3-dimensional plot 210. In some examples, a portion or portions 220, 230 of a kinematic map may not be useful due to physical limitations of the machine. In such cases, those portions 220, 230 of the kinematic map 210 may be removed. in FIG. 3, for example, the lower right portion 230 and the upper left portion 220 of the kinetic map 210 of FIG. 2 have been removed. The lower right portion 230 and the upper left portion 220 in this example relate to physical limitations of the lift cylinder, tilt cylinder, and bucket angle. In other words, the machine cannot physically maneuver to such positions. Therefore, for purposes of kinematic mapping and compression, these positions may be unnecessary to include in this map compression technique.

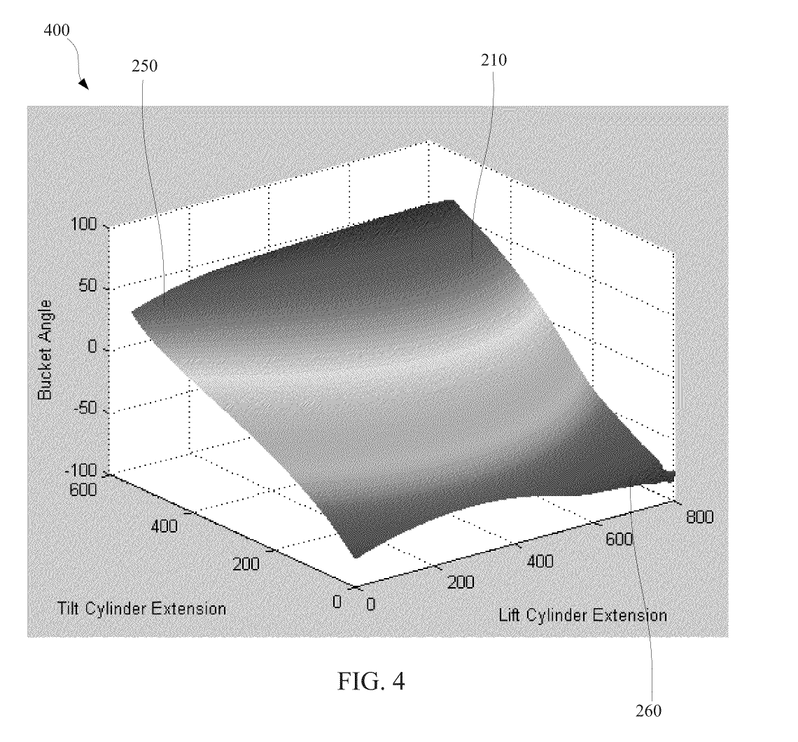

FIG. 4 depicts a graphical view of the example 3D kinematic map 400 of FIG. 3 with the removed portions 220, 230 replaced with linear estimated numerical values 250, 260. Example methods described herein utilize an entire kinematic map 400. Therefore, missing or removed portions 220, 230 of a kinematic map 400 should be replaced with linear estimated numerical values 250, 260. In some examples, linear estimated numerical values 250, 260 may be interpolated, extrapolated, and/or otherwise estimated from the kinematic map 400. These linear estimated numerical values 250, 260 then replace the removed portions 220, 230 on the kinematic map 400.

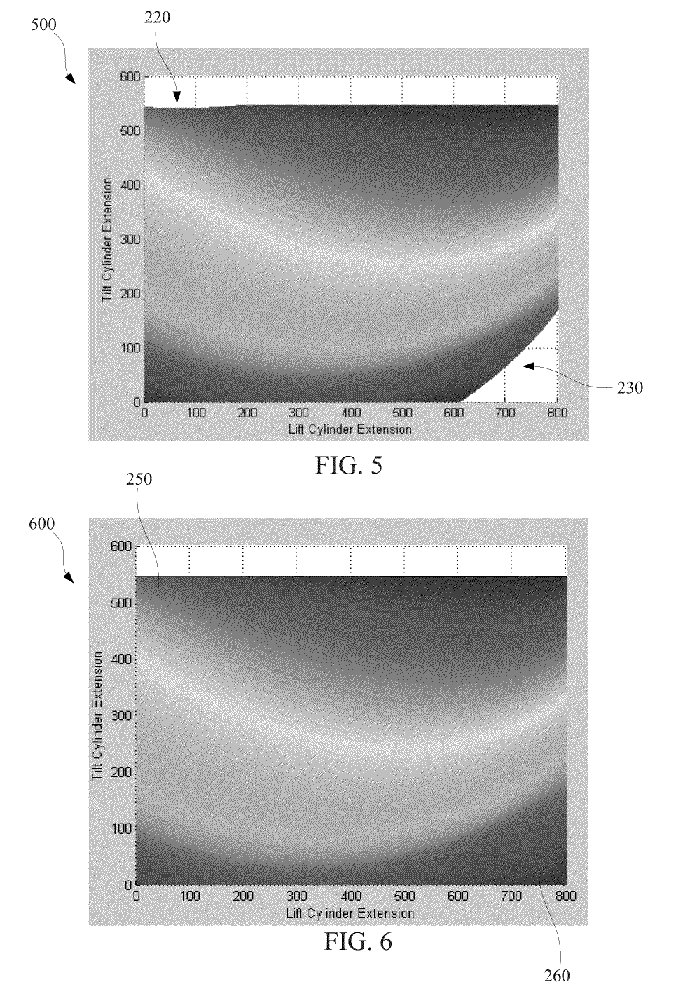

FIGS. 5 and 6 depict graphical views of the X-Y axis of the example 3D kinematic maps 300, 400 of FIG. 3 and FIG. 4, respectively. FIG. 5 depicts the X-Y axis (i.e., the lift cylinder extension axis and tilt cylinder extension axis) of the example 3D kinematic map 300 of FIG. 3. FIG. 5 clearly shows the removed portions 220, 230. FIG. 6 depicts the X-Y axis (i.e., the lift cylinder extension axis and tilt cylinder extension axis) of the example 3D kinematic map 400 of FIG. 4. FIG. 6 clearly shows that the removed portions 220, 230 are now replaced with linear estimated numerical values 250, 260. In this manner, the example 3D kinematic map 400 is a complete map without any portions removed or missing.

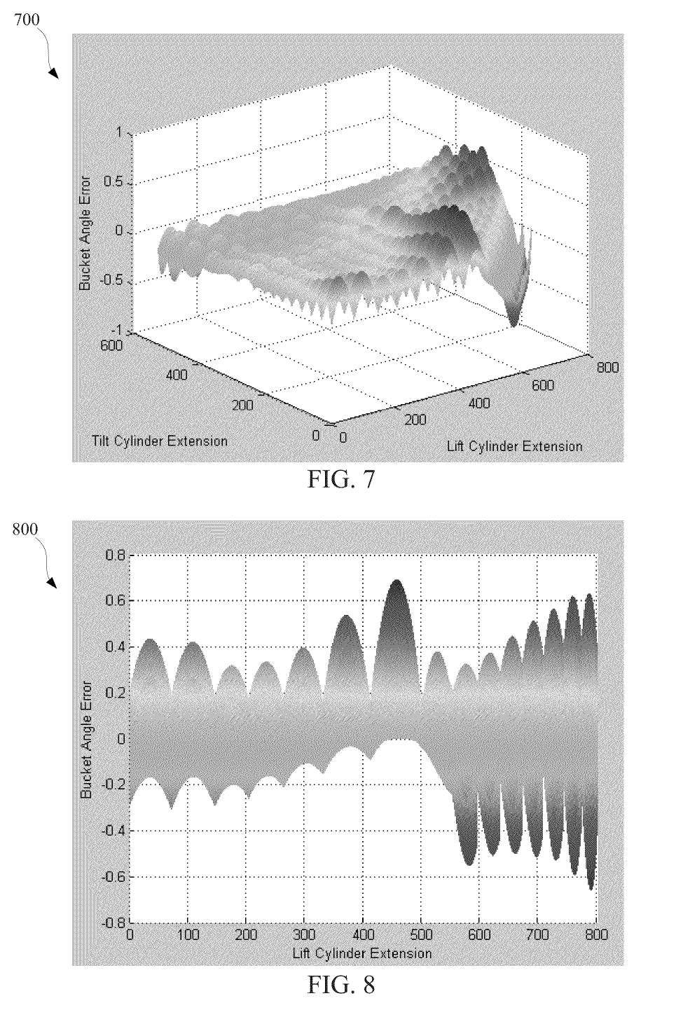

FIG. 7 depicts a graphical view of an example 3D interpolation error map 700. An interpolation error map 700 may be helpful to determine how well the reduced size 3D kinematic map compares to the original, initial size 3D kinematic map. The interpolation error map 700 plots the bucket angle error with respect to the lift cylinder extension and the tilt cylinder extension. FIG. 8 depicts a graphical view of the X-Z axis (i.e., the lift cylinder extension axis and bucket angle error axis) 800 of the example 3D interpolation error map 700 of FIG. 7. This view 800 of the 3D interpolation error map 700 may make it easier to determine default minimum and maximum bucket angles. The minimum bucket angles and maximum bucket angle may be reduced to 17 points each (corresponding to a 17×17 size).

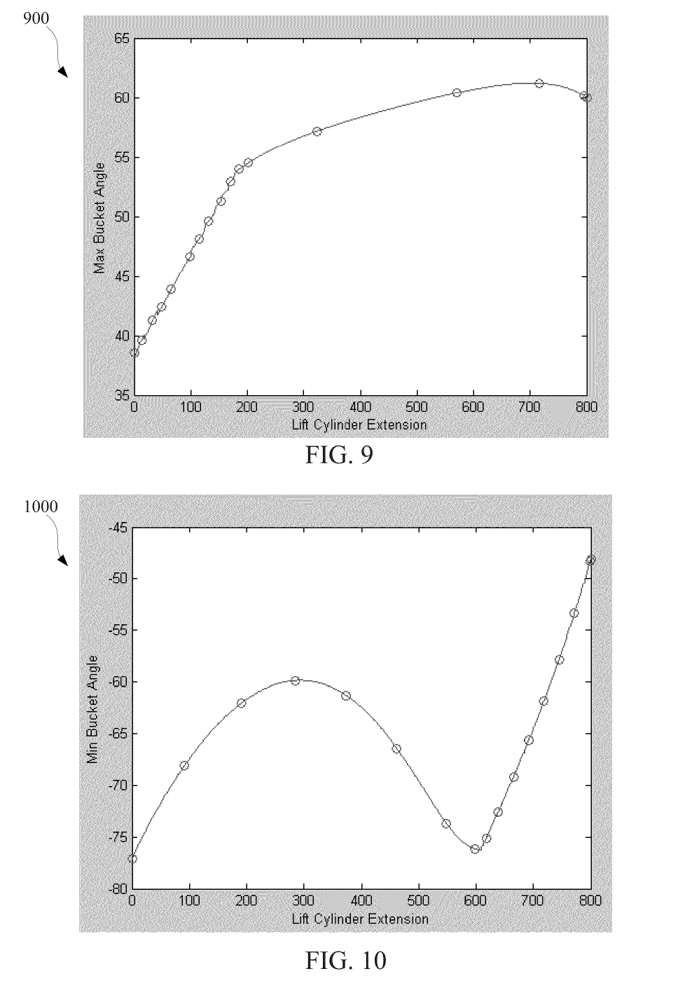

FIG. 9 depicts a graphical view 900 of example maximum bucket angles of a bucket. Specifically, FIG. 9 plots maximum bucket angles with respect to lift cylinder extension. FIG. 10 depicts a graphical view 1000 of example minimum bucket angles of a bucket. Specifically, FIG. 10 plots minimum bucket angles with respect to lift cylinder extension.

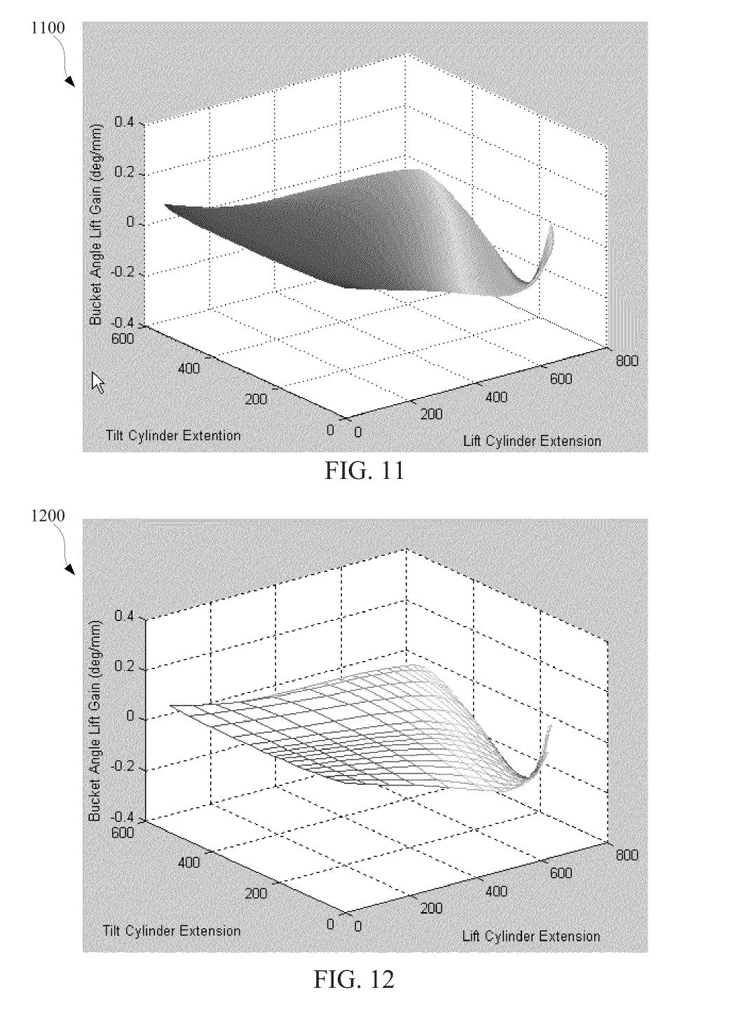

Bucket angle lift gain may be calculated and plotted. FIG. 11 depicts a graphical view of an example 3D kinematic map 1100 depicting example bucket angle lift gain. This example 3D kinematic map 1100 may be reduced from its initial size of 546×800 (as shown in FIG. 11) to a reduced size of 17×17 (as shown in FIG. 12). FIG. 12 depicts a graphical view of an example reduced size 3D kinematic map 1200 depicting example bucket angle lift gain of FIG. 11.

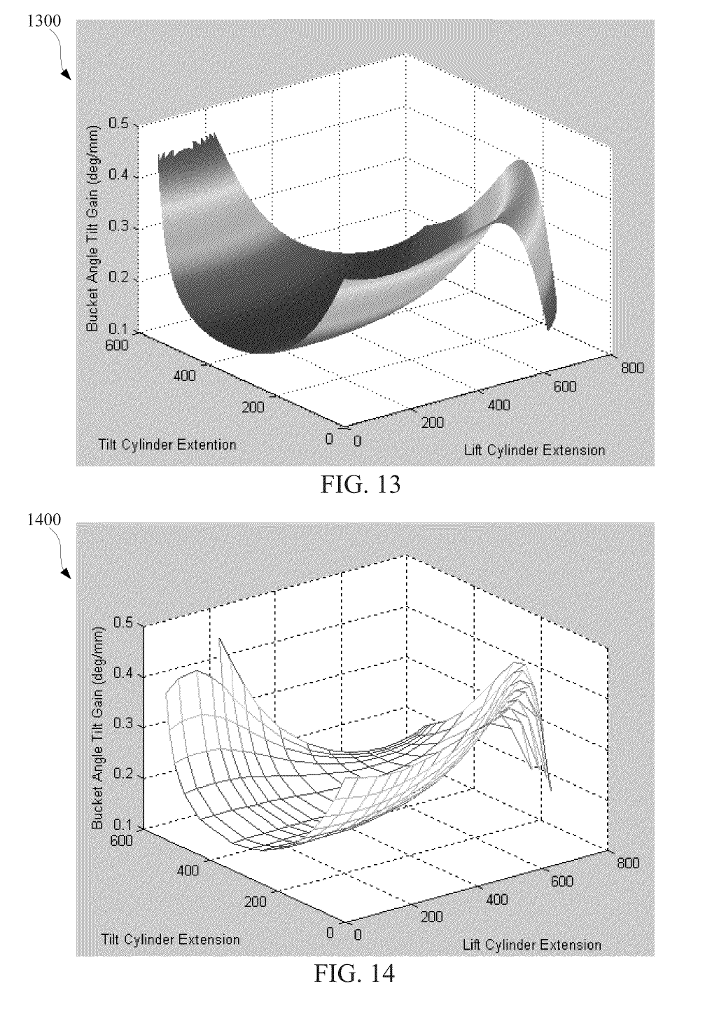

Bucket angle tilt gain may be calculated and plotted. FIG. 13 depicts a graphical view of an example 3D kinematic map 1300 depicting example bucket angle tilt gain. This example 3D kinematic map 1300 may be reduced from its initial size of 546×800 (as showing in FIG. 13) to a reduced size of 17×17 (as shown in FIG. 14). FIG. 14 depicts a graphical view of an example reduced size 3D kinematic map 1400 depicting example bucket angle tilt gain of FIG. 13.

In some examples, a kinematic map may be reduced to meet a target error tolerance. A target error tolerance value may be defined, received, or otherwise identified. This target error tolerance value may represent the maximum amount of error that a compressed 3D kinematic map may allow. This target error tolerance may be required and/or requested by an owner, operator, and/or machine limitation. A proposed reduced size may be inputted to begin the reduction process. For example, a proposed reduced size may be 21×8. Using the proposed. reduced size, the 3D kinematic map may be reduced using the techniques described herein.

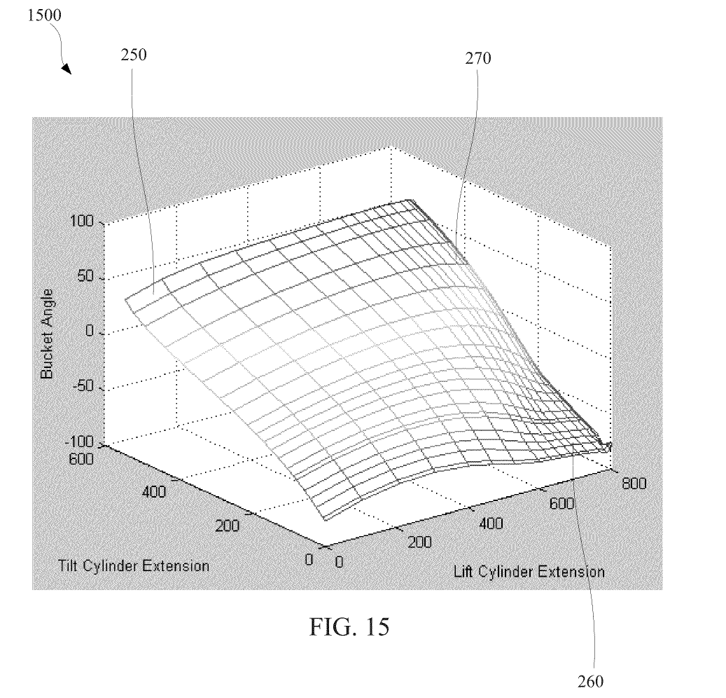

FIG. 15 depicts a graphical view of an example reduced size 3D kinematic map 1500 of FIG. 2. In this example, the original 3D kinematic map (546×801 size) 210 was reduced to a fixed size (21×18 size) 270 using an example modified DP searching technique. In this depicted example, the target error tolerance was defined as 0.75.

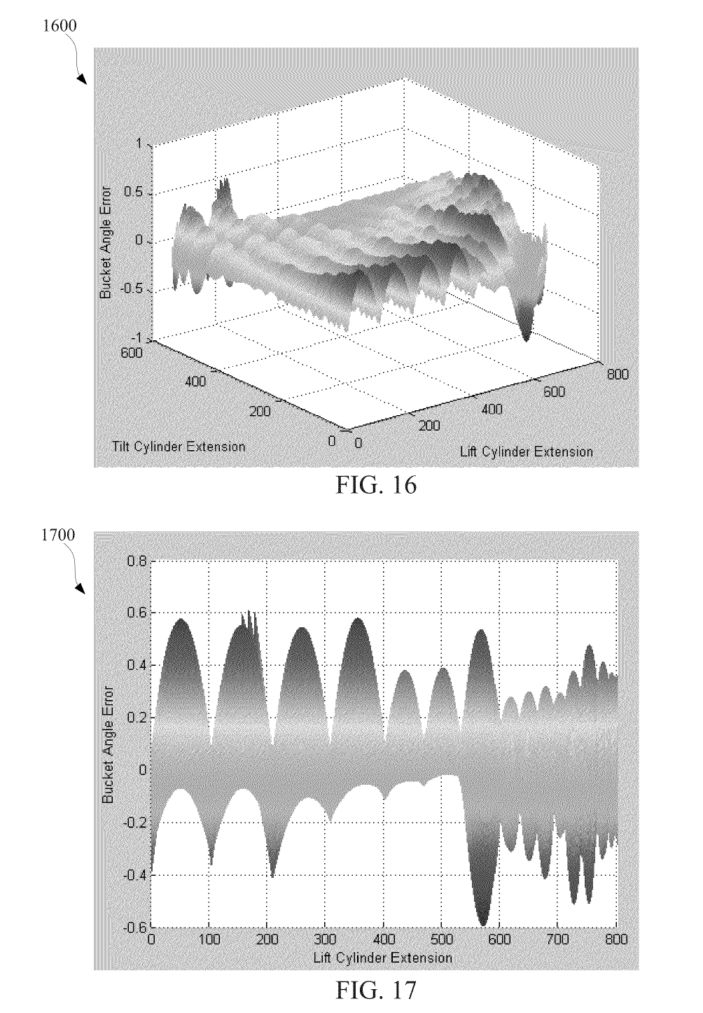

FIG. 16 depicts a graphical view of an example 3D interpolation error map 1600 of example bucket angle error of FIG. 15. An interpolation error map 1600 may be helpful to determine how well the reduced size 3D kinematic map compares to the original, initial size 3D kinematic map. The interpolation error map 1600 plots the bucket angle error with respect to the lift cylinder extension and the tilt cylinder extension.

FIG. 17 depicts a graphical view of the X-Z axis (i.e., the lift cylinder extension axis and bucket angle error axis) 1700 of the example 3D interpolation error map 1600 of bucket angle of FIG. 13. This view 1700 of the 3D interpolation error map 1600 may make it easier to determine error values to determine if the error is within the target error tolerance range. As shown in FIG. 17, the bucket angle error was within the target error tolerance of 0.75 (defined above). In the event that the bucket angle error is not within the target error tolerance, the process may be repeated using a new proposed reduced size. For example, if an initial proposed reduced size of 14×14 does not produce a result within the target error tolerance, a new proposed reduced size of 17×17 may be used. If a reduced size of 17×17 does not produce a result within the target error tolerance, anew proposed reduced size of 20×20 may be used. This iterative process, whether performed manually or in an automated manner, may continue until the bucket angle error is within the target error tolerance (as shown in FIG. 17).

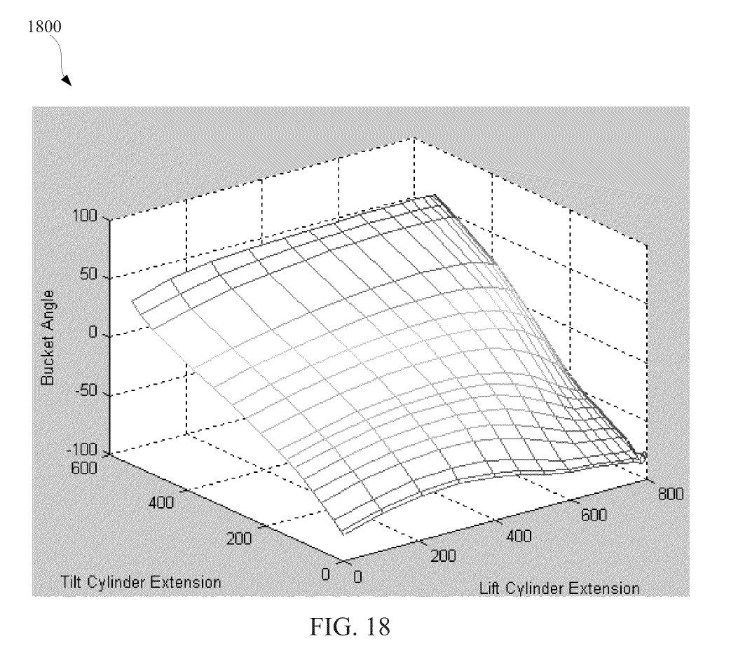

In some examples, a kinematic map may be reduced to meet a fixed size (e.g., 17×17). A fixed size may be defined, received, or otherwise identified. This fixed size may represent the maximum size that a compressed 3D kinematic map may be. This fixed size may be required and/or requested by an owner, operator, and/or machine limitation. For example, a machine owner may be comfortable with any amount of error present during compression, but may require a specific size kinematic map due to lack of on-board storage availability of the machine. FIG. 18 depicts a graphical view of an example reduced size 3D 1800 based on an example given fixed size using an example gradient search technique as described herein. In this depicted example, the fixed size was defined as 17×17.

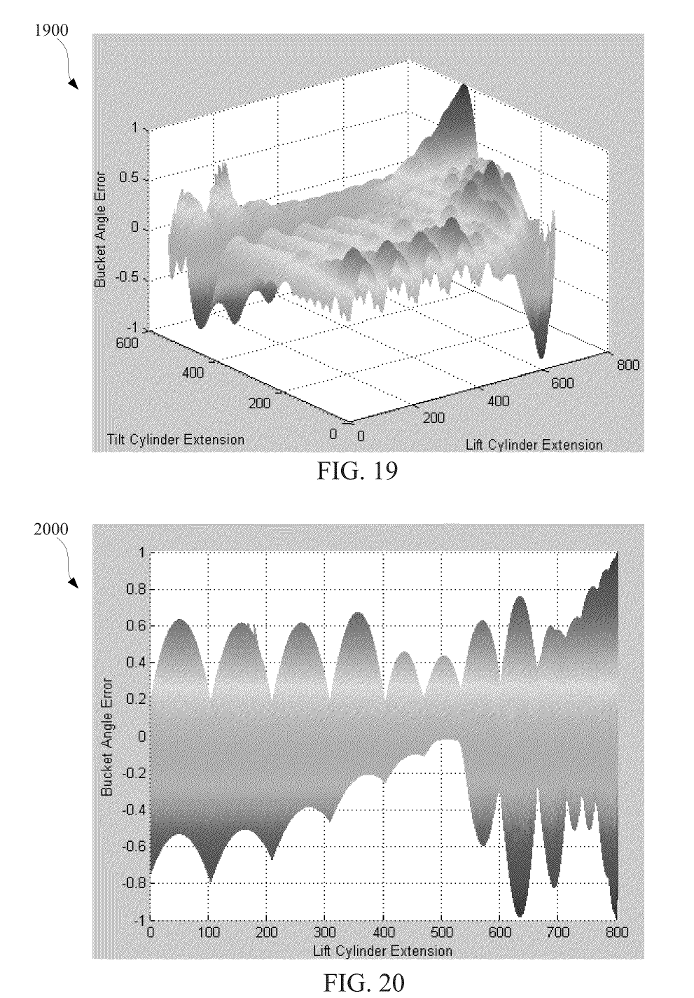

FIG. 19 depicts a graphical view of an example 3D interpolation error map 1900 of example bucket angle error of FIG. 18. Again, an interpolation error map 1900 may be helpful to determine how well the reduced size 3D kinematic map compares to the original, initial size 3D kinematic map. The interpolation error map 1900 plots the bucket angle error with respect to the lift cylinder extension and the tilt cylinder extension.

FIG. 20 depicts a graphical view of the X-Z axis (i.e., the lift cylinder extension axis and bucket angle error axis) 2000 of the example 3D interpolation error map 1900 of FIG. 19. This view 2000 of the 3D interpolation error map 1900 may make it easier to determine error values.

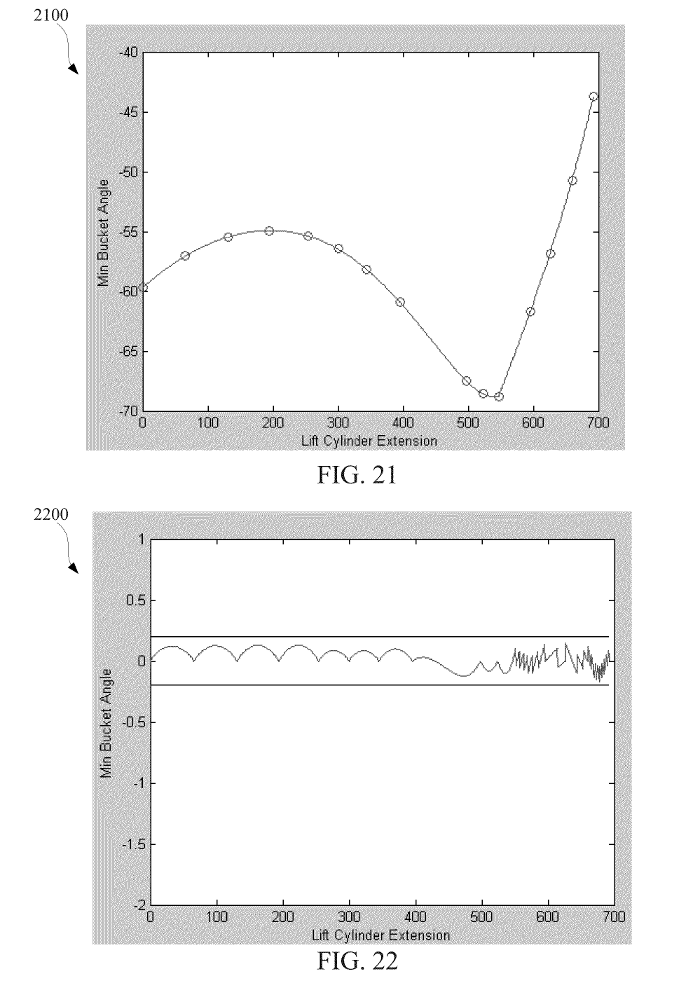

FIG. 21 depicts a graphical view of an example reduced size 2D kinematic map 2100 of minimum bucket angle based on an example given target error tolerance using an example gradient search technique as described herein. In this depicted example, the target error tolerance was defined as 0.2. This example 2D kinematic map 2100 plots the minimum bucket angles with respect to the lift cylinder extension. FIG. 22 depicts a graphical view 2200 of an example 2D interpolation nap 2200 of FIG. 21. An interpolation error map 2200 may be helpful to determine how well the reduced size 21) kinematic map compares to the original, initial size 2D kinematic map. This example 2D kinematic map 2200 plots the minimum bucket angle error with respect to the lift cylinder extension. As shown in FIG. 22, the minimum bucket angle error was within the target error tolerance of 0.2 (defined above).

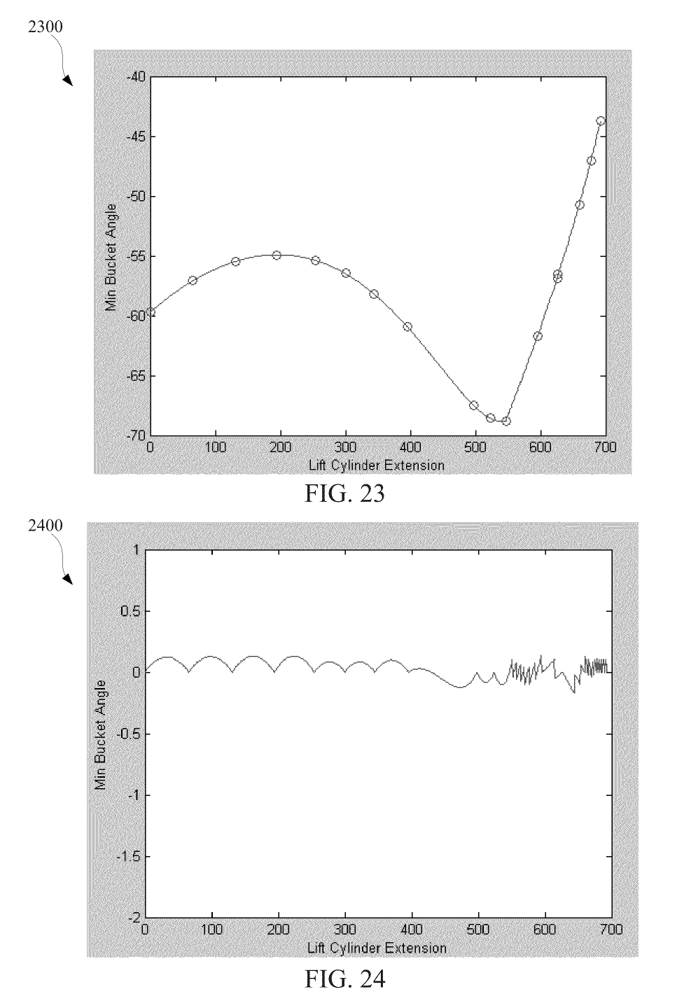

FIG. 23 depicts a graphical view of an example reduced size 2D kinematic map 2300 of minimum bucket angle based on an example given fixed size using an example gradient search technique as described herein. In this depicted example, the fixed size was defined as 17×17, This example 2D kinematic map 2300 plots the minimum bucket angles with respect to the lift cylinder extension. FIG. 24 depicts a graphical view of the example 2D interpolation error map 2400 of FIG. 23. An interpolation error map 2400 may be helpful to determine how well the reduced size 2D kinematic map compares to the original, initial size 2D kinematic map. This example interpolation error map 2400 plots the minimum bucket angle error with respect to the lift cylinder extension.

Example modified DP searching techniques generally relate to Douglas-Peucker algorithm, which is an algorithm for reducing the number of points in a curve that is approximated by a series of points. The Douglas-Peucker algorithm may also be known as the Ramer-Douglas-Peucker algorithm, the iterative end-point fit algorithm and/or the split-and-merge algorithm.

A purpose of the Douglas-Peucker algorithm is, given a curve composed of line segments, to find a similar curve with fewer points. The Douglas-Peucker algorithm defines ‘dissimilar’ based on the maximum distance between an original curve and a simplified curve. The simplified curve consists of a subset of the points that defined the original curve.

The starting curve is an ordered set of points or lines and the maximum allowable error due to interpolation as points are removed, ε. The Douglas-Peucker algorithm recursively divides the line. Initially, it is given all the points between the first and last point. it automatically marks the first and last point to be kept. It then finds the point that is furthest from the line segment with the first and last points as end points (this point is obviously furthest on the curve from the approximating line segment between the end points). If the point is closer than ε to the line segment then any points not currently marked to keep can be discarded without the smoothed curve being worse than ε.

If the point furthest from the line segment is greater than ε from the approximation then that point must be kept. The Douglas-Peucker algorithm recursively calls itself with the first point and the worst point and then with the worst point and the last point (which includes marking the worst point being marked as kept). When the recursion is completed a new output curve can be generated consisting of all (and only) those points that have been marked as kept.

The modified DP algorithm generally follows the same concept of the Douglas-Peucker algorithm but uses the linear interpolation error as the criteria to choose the points.

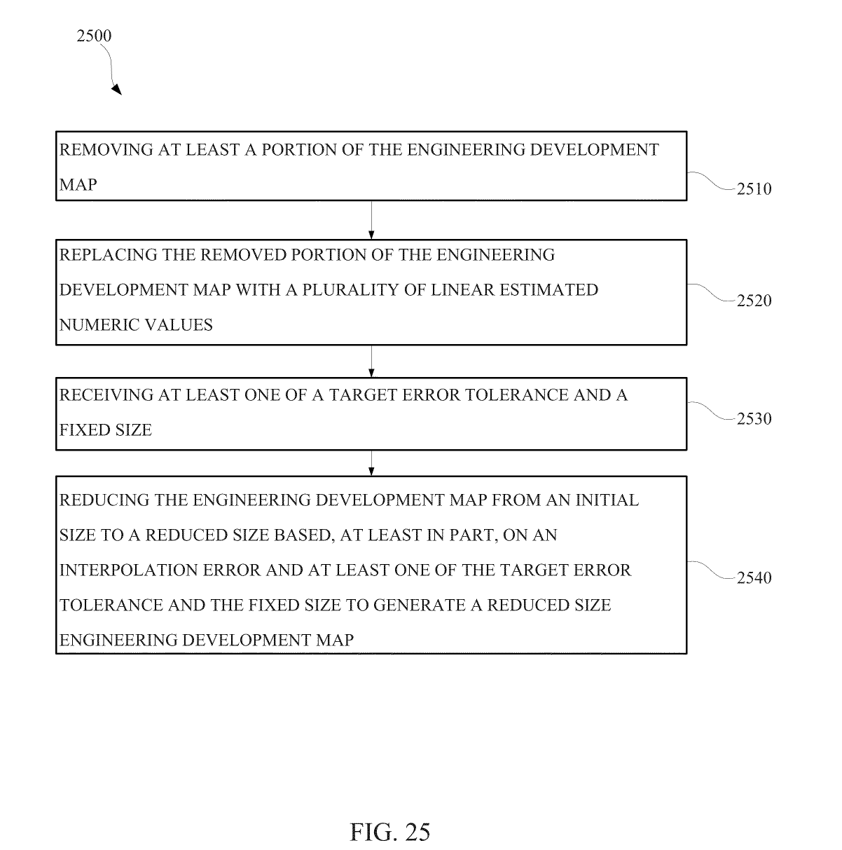

FIG. 25 depicts an example method 2500 of compressing an example kinematic map. Example method 2500 may include operations 2510, 2520, 2530 and/or 2540. Example method 2500 may include removing 2510 a portion of the kinematic map. Method 2500 then includes replacing 2520 the removed portion with linear estimated numeric values. Method 2500 may continue by receiving 2530 a target error tolerance and/or a fixed size. Method 2500 may then reduce 2540 the kinematic map from an initial size to a reduced size based, at least in part, on interpolation error and the target error tolerance and/or the fixed size to generate a reduced size kinematic map.

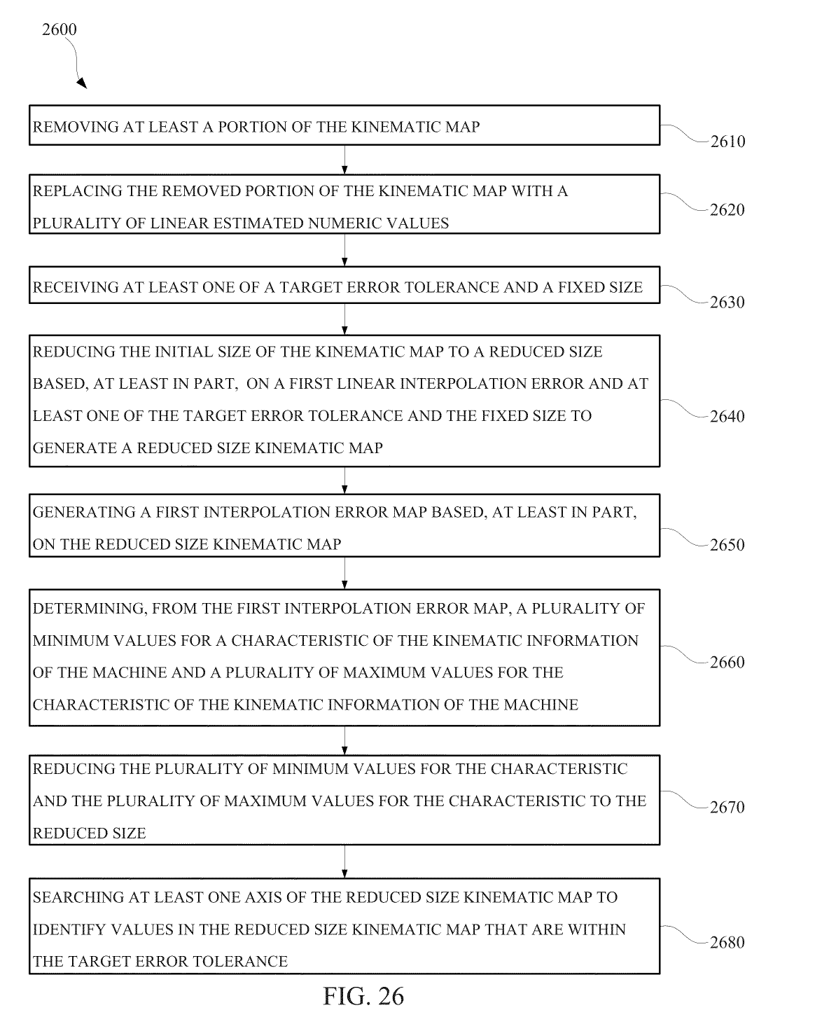

FIG. 26 depicts another example method 2600 of compressing an example kinematic map. Example method 2600 may include operations 2610, 2620, 2630, 2640, 2650, 2660, 2670 and/or 2680. Example method 2600 may include removing 2610 a portion of the kinematic map. Example method 2600 may also include replacing 2620 the removed portion of the kinematic map with linear estimated numeric values. Then, a target error tolerance and/or a fixed size may be received 2630. The initial size of the kinematic map may be reduced 2640 to a reduced size based, at least in part, on the interpolation error and the target error tolerance and/or the fixed size to generate a reduced size kinematic map. Example method 2600 may then generate 2650 a first interpolation error map based, at least in part, on the reduced size. Next, minimum values for a characteristic of the kinematic information of the machine and maximum values for the characteristic of the kinematic information of the machine may be determined 2660 from the first interpolation error map. The minimum values for the characteristic and the maximum values for the characteristic may be reduced 2670 to the reduced size. Example method 2600 may also include searching 2680 at least one axis of the reduced size kinematic map to identify values in the reduced size kinematic map that are within the target error tolerance.

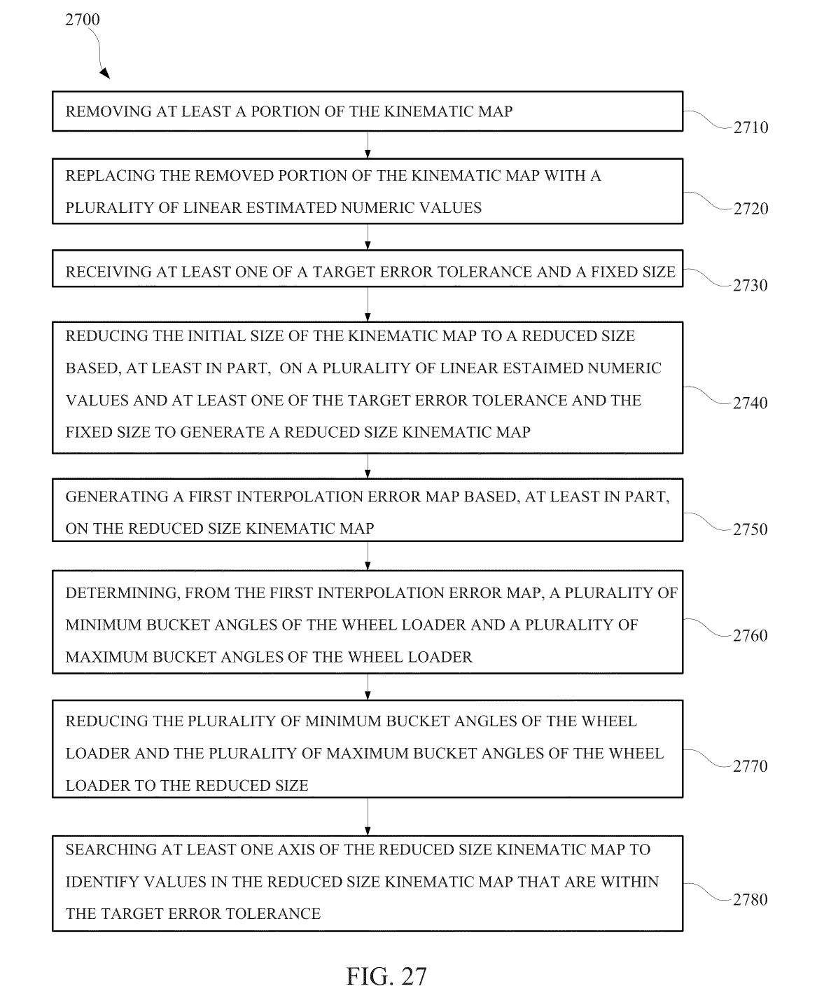

FIG. 27 depicts yet another example method 2700 of compressing an example kinematic map. Example method 2700 may include operations 2710, 2720, 2730, 2740, 2750, 2760, 2770 and/or 2780. Example method 2700 may include removing 2710 a portion of the kinematic map. Example method 2700 may also include replacing 2720 the removed portion of the kinematic map with linear estimated numeric values. Then, a target error tolerance and/or a fixed size may be received 2730. The initial size of the kinematic map may be reduced 2740 to a reduced size based, at least in part, on the interpolation error and the target error tolerance and/or the fixed size to generate a reduced size kinematic map. Example method 2700 may then generate 2750 a first interpolation error map based, at least in part, on the reduced size. Next, minimum bucket angles of the wheel loader and maximum bucket angles of the wheel loader may be determined 2760 from the first interpolation error map. The minimum bucket angles and the maximum bucket angles of the wheel loader may be reduced 2770 to the reduced size. Example method 2700 may also include searching 2780 at least one axis of the reduced size kinematic map to identify values in the reduced size kinematic map that are within the target error tolerance.

In some examples, a system for compressing a kinematic map representative of kinematic information of a machine may be provided. Example systems may include a computing device operatively enabled to perform the method(s) depicted in FIGS. 25, 26 and/or 27.

In some examples, an example non-transitory storage medium may include machine-readable instructions stored thereon which, when executed by processing unit(s) of a computing device, operatively enable the computing device to compress a kinematic map reprehensive of kinematic information of a machine. The kinematic map may have an initial size. The compressing may including removing at least a portion of the kinematic map, receiving a target error tolerance and/or a fixed size, and reducing the kinematic map from an initial size to a reduced size based, at least in part, on the interpolation error and the target error tolerance and/or the fixed size to generate a reduced size kinematic map.

Example computing devices may be of any suitable construction, however in one example it may include a digital processor system including a microprocessor circuit having data inputs and control outputs, operating in accordance with computer-readable instructions stored on a computer-readable medium. In some examples, the processor may have associated therewith long-term (non-volatile) memory for storing the program instructions, as well as short-term (volatile) memory for storing operands and results during (or resulting from) processing. Further, computing device may read computer-executable instructions from a computer-readable medium and executes those instructions. Example media readable by a computer may include both tangible and intangible media. Examples of the former include magnetic discs, optical discs, flash memory, RAM, ROM, tapes, cards, and the like. Examples of the latter include acoustic signals, electrical signals, AM and FM waves, etc. As used in the appended claims, the term “computer-readable medium” denotes only tangible media that are readable by a computer unless otherwise specifically noted.

### INDUSTRIAL APPLICABILITY

In construction and mining operations, machinery may have storage limitations. Example methods described herein may assist machinery owners to reduce the size (and therefore the storage requirement) of kinematic maps associated with the machinery.

Some machinery owners may value onboard memory space more than accuracy of compression of kinematic maps. In that case, those owners may wish to reduce the size of kinematic maps without regard (or with less regard) to the errors associated with said compression.

Some machinery owners may value accuracy of compression of kinematic maps more than onboard memory space. In that case, those owners may wish to maximize accuracy of the compressed kinematic maps with without regard (or with less regard) to the size of the compressed kinematic maps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of compressing an engineering development map representative of operational information of a machine, the engineering development map having an initial size, the method comprising:
removing at least a portion of the engineering development map;
replacing the removed portion of the engineering development map with a plurality of linear estimated numeric values;
receiving at least one of a target error tolerance and a fixed size; and
reducing the engineering development map from an initial size to a reduced size based, at least in part, on an interpolation error and at least one of the target error tolerance and the fixed size to generate a reduced size engineering development map.

2. The method of claim 1, wherein reducing the engineering development map includes generating an interpolation error map based, at least in part, on the reduced size engineering development map.

3. The method of claim 1, wherein reducing the engineering development map includes searching at least one axis of the reduced size engineering development map based, at least in part, on the target error tolerance.

4. The method of claim 3, wherein searching at least one axis of the reduced size engineering development map includes identifying values in the reduced size engineering development map that are within the target error tolerance.

5. The method of claim 4, wherein the reduced size engineering development map is based, at least in part, on the values in the reduced size engineering development map that are within the target error tolerance.

6. The method of claim 1, wherein the engineering development map and the reduced size engineering development map is two dimensional.

7. The method of claim 1, wherein the engineering development map and the reduced size engineering development map is three dimensional.

8. The method of claim 1, wherein the machine is a wheel loader.

9. The method of claim 8, wherein the operational information includes at least one of linkage information, a bucket angle, a bucket angle lift gain, a bucket angle tilt gain, a lift cylinder extension, and a tilt cylinder extension.

10. A system for compressing a kinematic map representative of kinematic information of a machine, the system having a computing device operatively enabled to perform the method of claim 1.

11. The system of claim 10, wherein the computing device is operatively enabled to search at least one axis of the reduced size engineering development map includes identifying values in the reduced size engineering development map that are within the target error tolerance.

12. A method of compressing a kinematic map representative of kinematic information of a machine, the kinematic map having an initial size, the method comprising:
removing at least a portion of the kinematic map;
replacing the removed portion of the kinematic map with a plurality of linear estimated numeric values;
receiving at least one of a target error tolerance and a fixed size;
reducing the initial size of the kinematic map to a reduced size based, at least in part, on a first linear interpolation error and at least one of the target error tolerance and the fixed size to generate a reduced size kinematic map;
generating a first interpolation error map based, at least in part, on the reduced size kinematic map;
determining, from the first interpolation error map, a plurality of minimum values for a characteristic of the kinematic information of the machine and a plurality of maximum values for the characteristic of the kinematic information of the machine;
reducing the plurality of minimum values for the characteristic and the of maximum values for the characteristic to the reduced size; and
searching at least one axis of the reduced size kinematic map to identify values in the reduced size kinematic map that are within the target error tolerance.

13. The method of claim 12, the method further including:
calculating a first gain value associated with the characteristic of the kinematic information of the machine;
generating a first gain value kinematic map;
removing at least a portion of the first gain value kinematic map;
replacing the removed portion of the first gain value kinematic map with a second plurality of linear estimated numeric values;
reducing a size of the first gain value kinematic map to the reduced size based, at least in part, on a second linear interpolation error to generate a reduced first gain value kinematic map; and
generating a second interpolation error map based, at least in part, on the reduced first gain value kinematic map.

14. The method of claim 13, the method further including:
calculating a second gain value associated with the characteristic of the kinematic information of the machine;
generating a second gain value kinematic map;
removing at least a portion of the second gain value kinematic map;
replacing the removed portion of the second gain value kinematic map with a third plurality of linear estimated numeric values;
reducing a size of the second gain value kinematic map to the reduced size based, at least in part, on a third linear interpolation error to generate a reduced second gain value kinematic map; and
generating a third interpolation error map based, at least in part, on the reduced second gain value kinematic map.

15. A method of compressing a kinematic map representative of kinematic information of a wheel loader, the kinematic map having an initial size, the method comprising:
removing at least a portion of the kinematic map;
replacing the removed portion of the kinematic map with a plurality of linear estimated numeric values;
receiving at least one of a target error tolerance and a fixed size;
reducing the initial size of the kinematic map to a reduced size based, at least in part, on a plurality of linear estimated numeric values and at least one of the target error tolerance and the fixed size to generate a reduced size kinematic map;
generating a first interpolation error map based, at least in part, on the reduced size kinematic map;
determining, from the first interpolation error map, a plurality of minimum bucket angles of the wheel loader and a plurality of maximum bucket angles of the wheel loader;
reducing the plurality of minimum bucket angles of the wheel loader and the plurality of maximum bucket angles of the wheel loader to the reduced size; and
searching at least one axis of the reduced size kinematic map to identify values in the reduced size kinematic map that are within the target error tolerance.

16. The method of claim 15, the method further including:
calculating a bucket angle lift gain value associated with the bucket angle of the wheel loader;
generating a bucket angle lift gain kinematic map;
removing at least a portion of the bucket angle lift gain kinematic map;
replacing the removed portion of the bucket angle lift gain kinematic map with a plurality of linear estimated numeric bucket angle lift gain values;
reducing a size of the bucket angle lift gain kinematic map to the reduced size to generate a reduced bucket angle lift gain kinematic map; and
generating a second interpolation error map based, at least in part, on the reduced bucket angle lift gain kinematic map.

17. The method of claim 16, the method further including:
calculating a bucket angle tilt gain value associated with the bucket angle of the wheel loader;
generating a bucket angle tilt gain kinematic map;
removing at least a portion of the bucket angle tilt gain kinematic map;
replacing the removed portion of the bucket angle lift gain kinematic map with a plurality of linear estimated numeric bucket angle tilt gain values;
reducing a size of the bucket angle tilt gain kinematic map to the reduced size to generate a reduced bucket angle tilt gain kinematic map; and
generating a second interpolation error map based, at least in part, on the reduced bucket angle tilt gain kinematic map.

18. The method of claim 15, wherein the kinematic map and the reduced size kinematic map are three dimensional, each including a bucket angle axis, a tilt cylinder extension axis, and a lift cylinder extension axis.

19. The method of claim 15, wherein the first interpolation error map is three dimensional and includes a bucket angle error axis, a tilt cylinder extension axis, and a lift cylinder extension axis.

20. The method of claim 19, wherein determining, from the first interpolation error map, a plurality of minimum bucket angles of the wheel loader and a plurality of maximum bucket angles of the wheel loader includes displaying a view of the bucket angle error axis and the tilt cylinder extension n axis of the first interpolation error map.
